(19) United States
(12) Patent Application Publication
(10) Pub. No.: US 2014/0340354 A1
(43) Pub. Date: Nov. 20, 2014

(54) MUTUAL CAPACITIVE TOUCH CONTROL DEVICE

(71) Applicant: MStar Semiconductor, Inc., Hsinchu Hsien (TW)

(72) Inventor: Tzu-Wei Liu, Zhubei City (TW)

(73) Assignee: MStar Semiconductor, Inc., Hsinchu Hsien (TW)

(21) Appl. No.: 14/277,143

(22) Filed: May 14, 2014

(30) Foreign Application Priority Data
May 15, 2013 (TW) 102117243

(51) Int. Cl. G06F 3/041; G06F 3/044

(52) U.S. Cl. CPC G06F 3/0418; G06F 3/044
USPC 345/174

(57) ABSTRACT

A mutual capacitive touch control device includes a sensing electrode, a first driving electrode and a second driving electrode. The sensing electrode includes a main stem, a plurality of electrode fingers and a plurality of second electrode fingers. The main stem has strip-shaped planar contour and a longer side parallel to a first direction. The first electrode fingers extend from the main stem toward a second direction perpendicular to the first direction. The second electrode fingers extend from the main stem toward opposite the second direction. The first driving electrode includes a first main body. The first main body has a plurality of first recesses corresponding to and interleaved with the first electrode fingers. The second driving electrode includes a second main body. The second main body has a plurality of second recesses corresponding to and interleaved with the second electrode fingers.

This application claims the benefit of Taiwan application Serial No. 102117243, filed May 15, 2013, the subject matter of which is incorporated herein by reference.

### BACKGROUND OF THE INVENTION

1. Field of the Invention

The invention relates in general to a touch control system, and more particularly, to a design of an electrode pattern in a touch control system.

2. Description of the Related Art

Operating interfaces of recent electronic products have become increasingly user-friendly and intuitive with the progressing technology. For example, through a touch screen, a user can directly interact with applications as well as input messages/texts/patterns with fingers or a stylus, thus eliminating complexities associated with other input devices such as a keyboard or buttons. In practice, a touch screen usually comprises a touch panel and a display provided at the back of the touch panel. According to a touch position on the touch panel and a currently displayed image on the display, an electronic device determines an intention of the touch to execute corresponding operations.

Existing capacitive touch sensing techniques can be roughly categorized into self capacitive and mutual capacitive types. FIG. 1 shows an electrode arrangement of a mutual capacitive touch panel in a single-layer electrode structure. Sensing electrodes S11 to S1N correspond to a driving electrode D1, sensing electrodes S21 to S2N correspond to a driving electrode D2, sensing electrodes S31 to S3N correspond to a driving electrode D3, and sensing electrodes S41 to S4N correspond to a driving electrode D4. Taking the driving electrode D1 and the corresponding sensing electrode S11 for example, when the driving electrode D1 carries a driving signal, the driving electrode D1 and the sensing electrode S11 have different electric potentials and thus a certain amount of power lines exist between the two. If a user finger approaches a unit sensing region formed by the driving electrode D1 and the sensing electrode S11, the power lines between the driving electrode D1 and the sensing electrode S11 are attracted by the finger, leading to a decrease in the mutual capacitance between the driving electrode D1 and the sensing electrode S11. An output signal of a receiver (not shown) connected to the sensing electrode S11 reflects such mutual capacitance change. According to the mutual capacitance changes provided by the receivers connected to the sensing electrodes and timings at which the driving signals are sent, a subsequent circuit is able to determine coordinates of a touch point.

The electrode arrangement in FIG. 1 contains two drawbacks. First of all, lengths of paths from the connected sensing electrodes to the corresponding receivers are different. For example, the length of a wire connecting the sensing electrode S11 is far shorter than the length of a wire connecting the sensing electrode S1N. Ideally, impedance values of the sensing electrodes against the receivers are preferably equal in order to prevent large variations in signals inputted into the receivers. Further, time points at which the driving electrodes D1, D2, D3 and D4 carry driving signals are also different, whereas the sensing electrodes are constantly in a status of receiving signals. Ideally, when the driving electrode D2 carries a driving signal, sensing electrodes with mutual capacitance changes are expectedly limited to the sensing electrodes S21 to S2N. However, as shown in FIG. 1, as the wire connecting the sensing electrode S1N is quite close to the driving electrode D2, the driving signal carried by the driving electrode D2 is much likely to be coupled to the sensing electrode D2, such that a slight mutual capacitance change may also occur at the sensing electrode S1N. This occurrence may lead a subsequent circuit to misjudge coordinates of a touch point.

FIG. 2 shows another electrode arrangement of a mutual capacitive touch panel in a single-layer electrode structure. As shown in FIG. 2, the sensing electrodes S11 to S1N and S21 to S2N are concentrated between the driving electrodes D1 and D2, and the sensing electrodes S31 to S3N and S41 to S4N are concentrated between the driving electrodes D3 and D4. An advantage of such electrode arrangement is that, with farther distances between the driving electrode D2 and the sensing electrodes S11 to S1N, driving signals are not coupled to the sensing electrodes S11 to S1N. Further, as the driving electrode D3 may provide the sensing electrodes S31 to S3N with a shielding effect, the sensing electrodes S31 to S3N are unaffected by the driving signal carried at the driving electrode. However, the electrode arrangement in FIG. 2 suffers from poor linearity. More specifically, distances between the driving electrodes are not equal, and unit sensing regions formed by the driving electrodes and the sensing electrodes are also unevenly distributed. Further, large variations in impedance values of the sensing electrodes against the receivers similarly exist in the electrode arrangement in FIG. 2.

### SUMMARY OF THE INVENTION

The invention is directed to an electrode pattern for a mutual capacitive touch control device. By adopting an electrode arrangement different from the prior art, the mutual capacitive touch control device according to the present invention is capable of preventing the issues of impedance mismatch of sensing electrodes and poor linearity. Further, by adding a shielding portion to driving electrodes, the mutual capacitive touch control device according to the present invention also lowers the possibility of a subsequent circuit misjudging coordinates of a touch point.

According to an embodiment of the present invention, a mutual capacitive touch control device is provided. The mutual capacitive touch control device includes a sensing electrode, a first driving electrode and a second driving electrode. The sensing electrode includes a main stem, a plurality of first electrode fingers and a plurality of second electrode fingers. The main stem has a substantially strip-shaped planar contour and a longer side substantially parallel to a first direction. The first electrode fingers have substantially rectangular planar contours and extend from the main stem toward a second direction. The second electrode fingers have substantially rectangular planar contours and extend from the main stem toward opposite the second direction. The first direction and the second direction are substantially perpendicular. The first driving electrode includes a first main body. The first main body has a plurality of first recesses corresponding to and interleaved with the first electrode fingers, and forms a first sensing region with the first electrode fingers. The second driving electrode includes a second main body. The second main body has a plurality of second recesses corresponding to and interleaved with the second electrode fingers, and forms a second sensing region with the second electrode fingers.

According to another embodiment of the present invention, a mutual capacitive touch control device is provided. The mutual capacitive touch control device includes a sensing electrode, a first driving electrode and a second driving electrode. The sensing electrode includes a first sensing section and a second sensing section. The first driving electrode includes a first main body, and corresponds to and forms a first sensing region with the first sensing section. The second driving electrode includes a second body, and corresponds to and forms a second sensing region with the second sensing section. The first sensing region and the second sensing region are adjacent to each other with an adjoining region in between. The first driving electrode further includes a shielding portion extending from the first main body toward the adjoining region.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is diagram of an electrode arrangement of a mutual capacitive touch panel in a single-layer electrode structure in the prior art;

FIG. 2 is a diagram of another electrode arrangement of a mutual capacitive touch panel in a single-layer electrode structure in the prior art;

FIG. 3(A) is a diagram of a partial electrode arrangement of a single-layer mutual capacitive touch control system according to an embodiment of the present invention;

FIG. 3(B) redraws a sensing electrode and a plurality of driving electrodes in FIG. 3(A) to illustrate the definition of a unit sensing region;

FIG. 3(C) is an electrode pattern as a result of repetitively arranging several of the electrode combination in FIG. 3(A).

FIG. 3(D) is an example of a driving electrode further including a shielding portion;

FIG. 3(E) is an example of adding connecting wires to the driving electrodes in the electrode combination shown in FIG. 3(D);

FIG. 3(F) is another example of adding connecting wires to the driving electrodes in the electrode combination shown in FIG. 3(D);

FIG. 4(A) and FIG. 4(B) show electrode patterns before and after adding a shielding portion according to an embodiment of the present invention.

### DETAILED DESCRIPTION OF THE INVENTION

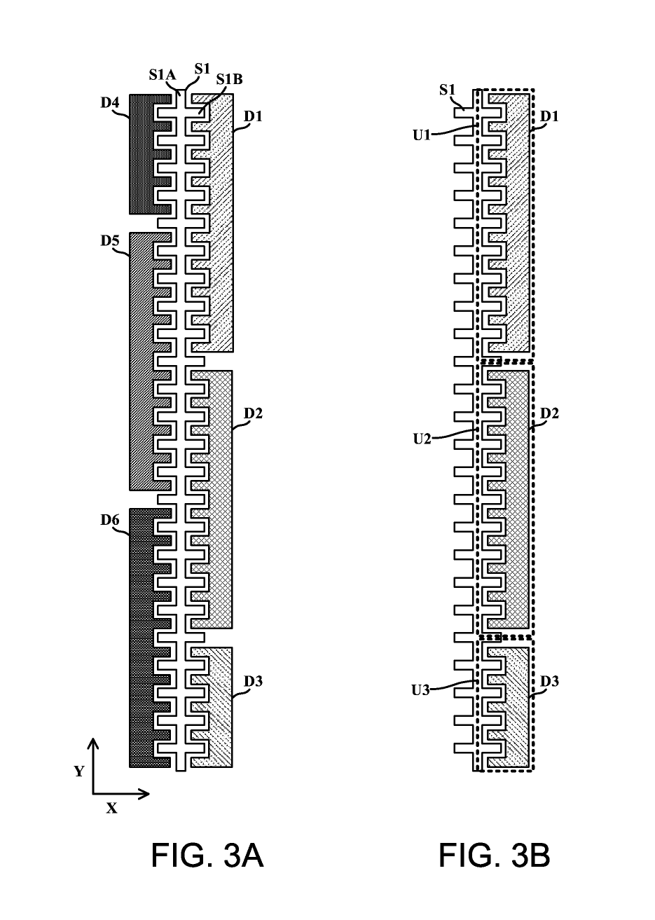

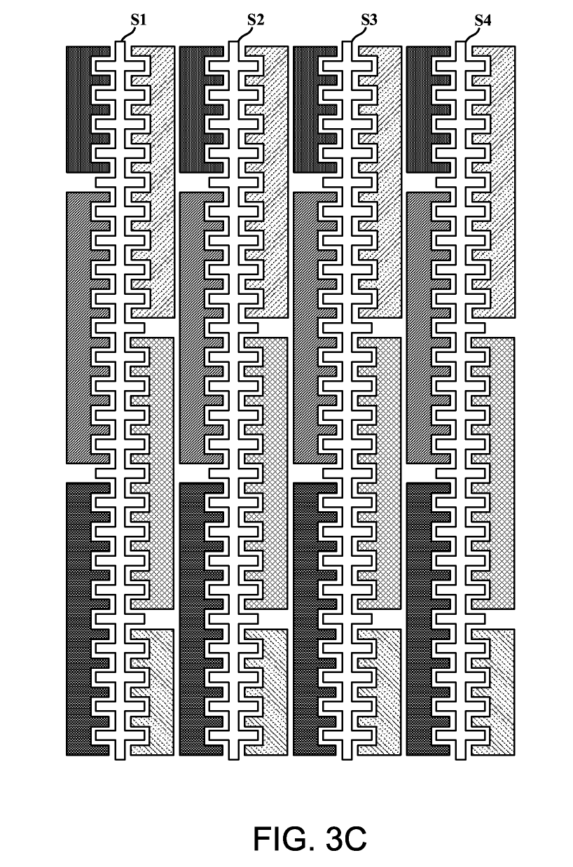

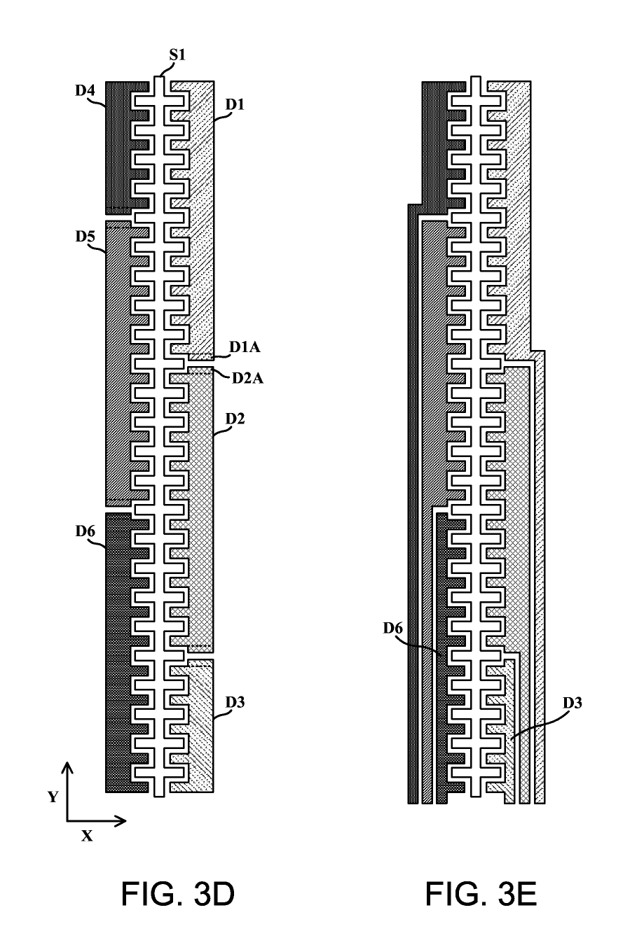

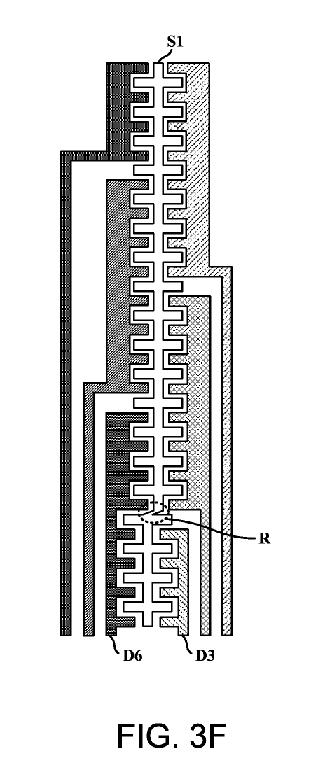

A single-layer mutual capacitive touch control system is provided according to an embodiment of the present invention. FIG. 3(A) shows a partial electrode arrangement of the single-layer mutual capacitive touch control system, which can be regarded as an electrode combination. The electrode denoted S1 is a sensing electrode, and electrodes denoted D1 to D6 are independent driving electrodes. As shown in FIG. 3(A), a main stem S1A of a sensing electrode S1 has a substantially strip-shaped planar contour and has a longer side substantially parallel to the Y direction. The sensing electrode S1 further includes a plurality of electrode fingers, e.g., electrode fingers S1B. The electrode fingers having substantially rectangular planar contours extend from the main stem S1A toward the X direction or toward opposite the X direction. As shown in FIG. 3(A), each of the main bodies of the driving electrodes D1 to D6 has a plurality of recesses, which correspond to and interleave with the electrode fingers of the sensing electrode S1.

Theoretically, power lines affected by a user touch are mainly distributed near spaces between the driving electrodes and the sensing electrode. Referring to an example in FIG. 3(B), in which the sensing electrode S1 and the driving electrodes D1, D2 and D3 are redrawn, the recesses of the driving electrode D1 and the corresponding electrode fingers of the sensing electrode S1 form a sensing region U1 represented by a dotted frame; the recesses of the driving electrode D2 and the corresponding electrode fingers of the sensing electrode S1 form another sensing region U2; the recesses of the driving electrode D3 and the corresponding electrode fingers of the sensing electrode S1 form another sensing region U3. Similarly, each of the driving electrodes adjacent to the sensing electrode S1 corresponds to a unit sensing region.

As seen from FIG. 3(A), the driving electrodes located at the left and right of the sensing electrode S1 are asymmetrical along the Y direction. Taking the driving electrodes D1, D2 and D5 for example, a part of the electrode fingers corresponding to the driving electrode D5 and a part of the electrode fingers corresponding to the driving electrode D1 have the same positions along the X direction, and a part of the electrode fingers corresponding to the driving electrode D5 and a part of the electrode fingers corresponding to the driving electrode D2 have the same positions along the X direction. Compared to a left-right symmetrical arrangement, such approach offers an advantage of enhancing a resolution of a sensing result.

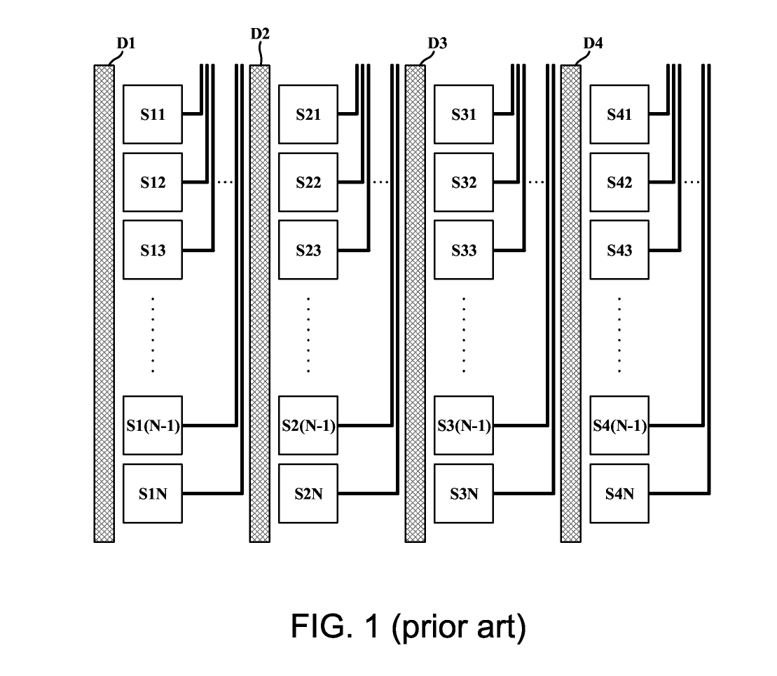

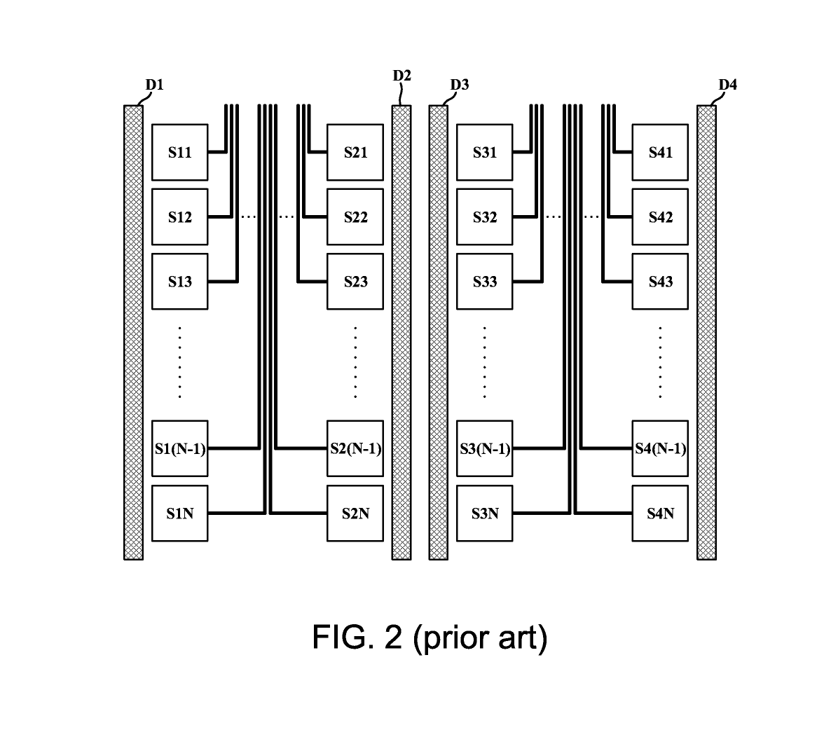

FIG. 3(C) shows an electrode pattern composed of several duplicated electrode combinations shown in FIG. 3(A) along the X direction. To maintain a clear diagram, only sensing electrodes S1 to S4 serving as centers of the electrode combinations are denoted in FIG. 3(C). Comparing FIG. 3(C) with FIG. 1 and FIG. 2, different from a conventional approach of multiple sensing electrodes collaborating with one driving electrode (e.g., the sensing electrodes S11 to S1N collaborating with the driving electrode D1 in FIG. 1), in the embodiment, multiple driving electrodes collaborate with one sensing electrode, and the driving electrodes are disposed at two sides of the sensing electrode. An advantage of such approach is that, as total lengths of the sensing electrodes in this arrangement are substantially equal, the issue of impedance mismatch of sensing electrodes in the prior art can be solved. Further, compared to electrodes having straight edges in the prior art, the multiple electrode fingers of the sensing electrode and the corresponding recesses of the driving electrodes increase the number of power lines affected by a user touch, thereby increasing the mutual capacitance change, i.e., enhancing a signal-to-noise ratio of the sensing signal. Further, as shown in FIG. 3(C), spaces between the sensing electrodes are quite even. Given widths of the driving electrodes and sensing electrodes are appropriately designed, the issue of poor linearity as in the conventional approach in FIG. 2 can be eliminated.

In another embodiment, as shown in FIG. 3(D), apart from the main body, each of the driving electrodes further includes at least one shielding portion (distinguished from the main body by a dotted line) extending from the main body along the Y direction. A shielding portion D1A of the driving electrode D1 and a shielding portion D2A of the driving electrode D2 are taken as an example for illustration below. As shown in FIG. 3(B), the sensing region U1 and the sensing region U2 are adjacent to each other with an adjoining region in between. The shielding portion D1A of the driving electrode D1 extends from the corresponding main body toward the adjoining region. Similarly, the shielding portion D2A of the driving electrode D2 also extends from the corresponding main body toward the adjoin region. When the driving electrode D1 carries a driving signal, the shielding portion D2A provides the sensing electrode S1 in the sensing region U2 with a shielding effect, which prevents the sensing electrode S1 in the sensing region U2 from contributing a mutual capacitance change. Similarly, when the driving signal D2 carries a driving signal, the shielding portion D1A provides the sensing electrode S1 in the sensing region U1 with a shielding effect, which prevents the sensing electrode S1 in the sensing region U1 from contributing a mutual capacitance change. Thus, the possibility of a subsequent circuit misjudging coordinates of a touch point is lowered.

FIG. 3(E) shows an example of adding connecting wires to the driving electrodes in the electrode combination in FIG. 3(D). It should be noted that, in FIG. 3(E), widths of the main bodies of the driving electrodes D3 and D6 along the X direction are slightly reduced. Such approach is suitable for a situation where the driving electrodes D3 and D6 are near border regions of a touch panel. In FIG. 3(E), the border regions are located not far from the bottom of the diagram. By appropriately reducing the widths of certain electrodes, widths and line spaces the connecting wires of all driving electrodes near the border regions can be substantially equal. That is to say, according to an embodiment of the present invention, the widths of the driving electrodes collaborating with the same sensing electrode need not be equal. Also seen from FIG. 3(E), the main body of the driving electrode D2 is capable of shielding the sensing region U2 against influences that the wires of the driving electrode D1 pose on the sensing region U2. In practice, an electrode pattern designer may determine the widths of the driving electrodes along the X direction according to the desired magnitude of shielding effects.

FIG. 3(F) shows another example of adding connecting wires to the driving electrodes in the electrode combination in FIG. 3(D). In the embodiment, the sensing electrode S1 substantially appearing strip-shaped is slightly bent in a range R represented by a dotted line. Further, as shown in FIG. 3(F), the width of an upper half of the driving electrode D6 is greater than the width of a lower half. These adjustments are aimed to render the widths and line spaces of the connecting wires of all the electrodes near the border regions to be substantially equal. It should be noted that, ratios of the line widths, line spaces, lengths and widths of the electrodes in the above examples are for explaining the present invention, not limiting the present invention.

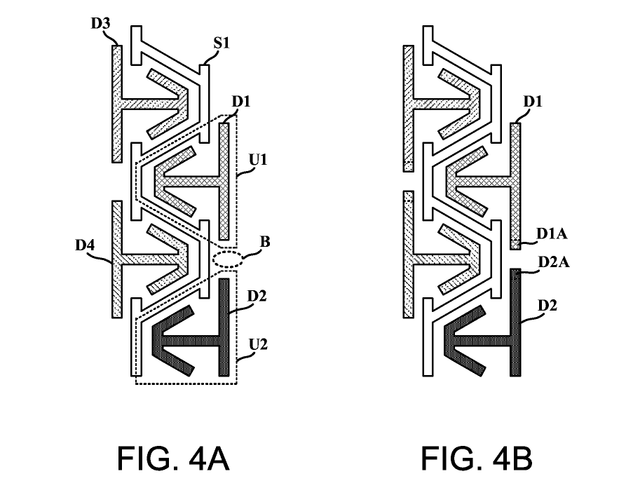

One person skilled in the art can easily understand that, the concept of the shielding portion disclosed by the present invention for providing an adjacent sensing region with a shielding effect is further applicable to a mutual capacitive electrode combination containing one sensing region collaborating with a plurality of driving electrodes other than the example shown in FIG. 3(A). FIG. 4(A) shows an electrode pattern before adding a shielding portion; FIG. 4(B) shows an electrode pattern after adding a shielding portion. The sensing electrode S1 includes a plurality of sensing sections respectively corresponding to the driving electrodes D1 to D4. In the embodiment, taking the first driving electrode D1 and the second driving electrode D2 for example, the first driving electrode D1 and the corresponding sensing section form a first sensing region U1, and the second driving electrode D2 and the corresponding sensing section form a second sensing region U2. The first sensing region U1 and the second sensing region U2 are adjacent to each other with an adjoining region in between. The adjoining region is substantially a region B represented by a dotted frame in FIG. 4(A). The first driving electrode D1 includes a shielding portion D1A extending from the corresponding main body toward the adjoining region. The shielding portion D1A provides the first sensing region U1 with a shielding effect against influences of the second driving electrode D2. Similarly, the second driving electrode D2 includes a shielding portion D2A extending from the corresponding main body toward the adjoining region. The shielding portion D2A provides the second sensing region U2 with a shielding effect against influences of the first driving electrode D1.

An electrode pattern for a mutual capacitive touch control device is disclosed as above. By adopting an electrode arrangement different from the prior art, the mutual capacitive touch control device according to the present invention is capable of preventing the issues of impedance mismatch of sensing electrodes and poor linearity. Further, by adding a shielding portion to driving electrodes, the mutual capacitive touch control device according to the present invention also lowers the possibility of a subsequent circuit misjudging coordinates of a touch point.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A mutual capacitive touch control device, comprising:
a sensing electrode, comprising a main stem, a plurality of first electrode fingers and a plurality of second electrode fingers, the main stem having a strip-shaped planar contour and a longer side parallel to a first direction, the first electrode fingers having rectangular planar contours and extending from the main stem toward a second direction, the second electrode fingers having rectangular planar contours and extending from the main stem toward opposite the second direction, the first direction being perpendicular to the second direction;
a first driving electrode, comprising a first main body, the first main body having a plurality of recesses corresponding to and interleaved with the first electrode fingers, the first driving electrode and the first electrode fingers forming a first sensing region;
a second driving electrode, comprising a second main body, the second main body having a plurality of recesses corresponding to and interleaved with the second electrode fingers, the second driving electrode and the second electrode fingers forming a second sensing region.

2. The mutual capacitive touch control device according to claim 1, wherein the main stem further comprises a plurality of third electrode fingers, the third electrode fingers have rectangular planar contours and extend from the main stem toward the second direction; the mutual touch control device further comprising:
a third driving electrode, comprising a third main body, the third main body having a plurality of third recesses corresponding to and interleaved with the third electrode fingers, the third driving electrode and the third electrode fingers forming a third sensing region.

3. The mutual capacitive touch control device according to claim 2, wherein the first sensing region and the third sensing region are adjacent to each other with an adjoining region in between, and the first driving electrode further comprises a shielding portion extending from the first main body toward the adjoining region.

4. The mutual capacitive touch control device according to claim 2, wherein a part of the second electrode fingers and a part of the first electrode fingers have different positions along the first direction.

5. The mutual capacitive touch control device according to claim 2, wherein the first main body has a first width along the second direction, the third main body has a second width along the second direction, and the first width is different from the second width.

6. A mutual capacitive touch control device, comprising:
a sensing region, comprising a first sensing section and a second sensing section;
a first driving electrode, corresponding to and forming a first sensing region with the first sensing section; and
a second driving electrode, comprising a second main body, corresponding to and forming a second sensing region with the second sensing section;
wherein, the first sensing region and the second sensing region are adjacent to each other with an adjoining region in between, and the first driving electrode further comprises a first shielding portion extending from the first main body toward the adjoining region.

7. The mutual capacitive touch control device according to claim 6, wherein the second driving electrode further comprises a second shielding portion extending from the second main body toward the adjoining region.
